(19) United States
(12) Patent Application Publication
(10) Pub. No.: US 2024/0062317 A1
(43) Pub. Date: Feb. 22, 2024

(54) INTEGRATED SYSTEM FOR AUTHENTICITY VERIFICATION, USER ENGAGEMENT IN SOCIAL NETWORKING PLATFORMS AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/452,828

(22) Filed: Aug. 21, 2023

Related U.S. Application Data
(60) Provisional application No. 63/400,042, filed on Aug. 22, 2022.

(51) Int. Cl. G06Q 50/00; G06F 21/62; G06F 3/04845

(52) U.S. Cl. CPC G06Q 50/01; G06F 21/6218; G06F 3/04845; G06F 2221/2141

(57) ABSTRACT

The present invention discloses an integrated system (100) within the online social networking platforms (101), designed to ensure authenticity and amplify user engagement. The system (100) orchestrates the enabling of users to upload both avatar and real images, linked to their profiles, thus giving rise to bona fide visual identities. Facilitated by a user-friendly interface (103), the system (100) provides effortless transitions between avatar and real profile images, thereby enriching engagement encounters. The assurance of controlled access to authentic image profiles is administered through a permission management module (105). Moreover, the system employs placeholder notifications to gently guide users in aligning their visual identities, thus fostering an environment that embodies authenticity, security, and heightened engagement within the online social networking realm.

### PRIORITY CLAIM

This application claims priority from U.S. provisional application Ser. No. 63/400,042 filed on 22 Aug. 2022 entitled “METHODS AND SYSTEMS OF ONLINE SOCIAL NETWORKING”, the entirety of which herein is incorporated by reference.

### DESCRIPTION OF THE INVENTION

### Technical Field of the Invention

The present invention relates to a field of online social networking platforms, with a primary emphasis on augmenting authenticity and engagement. Specifically, the invention discloses an integrated system that enables users to upload and switch between avatar and real images, fostering authentic interactions and connections within the online social networking landscape.

### BACKGROUND OF THE INVENTION

In the era of digital technology advancements, online social networking platforms have introduced revolutionary changes to the ways individuals establish connections, communicate, and share diverse forms of content. These platforms have effectively established a virtual environment where users possess the capability to express personal viewpoints, share experiences, and communicate thoughts, transcending geographical limitations. The pervasive influence of these platforms in modern communication is substantial, as they seamlessly integrate into the fabric of contemporary societal interaction.

Amid the substantial advantages offered by these online social networking platforms, several challenges have emerged, significantly influencing the quality of interactions within this digital realm. An important challenge pertains to the concept of authenticity, focusing on ensuring that the identities, engagements, and content shared on these platforms accurately represent the true nature of individuals. This concern stems from the recognition that digital personas crafted on these platforms may not consistently align with users' genuine identities, leading to ambiguity regarding the authenticity of connections and shared content. Despite the extensive reach and accessibility these platforms offer, there is a growing demand for fostering interactions that transcend superficiality. The proliferation of numerous interactions, often characterized by brevity and shallowness, poses an obstacle to establishing meaningful connections.

Another significant challenge pertains to content credibility. The vast expanse of information disseminated through these platforms encompasses a diverse range of content types, spanning from news and opinions to personal anecdotes. The accuracy and reliability of this content are frequently subject to doubt, underscoring the importance of implementing mechanisms that enhance content credibility and safeguard users from misinformation or manipulation. In essence, as online social networking platforms redefine communication by establishing a dynamic virtual domain for connections and expressions, they simultaneously give rise to critical concerns. These encompass the authenticity of digital identities, the depth of user interactions, and the credibility of shared content. As these platforms continue to be deeply ingrained in modern society, addressing these challenges is imperative to ensure the responsible harnessing of their transformative potential and to enable users to engage in genuine, enriching interactions within the digital landscape.

While conventional approaches rely on pseudonyms or avatars to represent users, there is a growing demand for more genuine and accountable online interactions. While this practice provides a degree of privacy, it can also result in the dilution of genuine interactions and transparency. Users often lack the means to verify the authenticity of the individuals they engage with or the content they consume. This raises concerns about the credibility of information shared, potential misrepresentations, and even the prevalence of harmful activities. Users' real-life identities are often obscured, leading to potential misrepresentations, privacy concerns, and diluted user engagement experiences. Additionally, the authenticity of the content shared on these platforms becomes a paramount consideration to foster credible interactions and maintain the platform's integrity. To address these challenges, there is a need for innovative solutions that enhance the authenticity of user interactions and content while promoting meaningful engagements within online social networks.

The Patent Application No. US20190044931A1 titled “Method and system to authenticate and improve reliability of user-provided data for a social network” pertains to a system and method for authenticating and improving reliability of personal data provided to and stored within a social media network. The social media network server executes instructions to: receive authentication data for a data entry in a social media profile from a computing device of an account holder; identify an authentication data type corresponding to the authentication data; extract data from authentication data based on identified authentication data type; store a set of the extracted data; use a set of the stored data in a targeted pairing algorithm; retrieve predetermined authentication characteristics; examine the authentication data for an existence of each of the predetermined authentication characteristics; reconcile the authentication data with the associated data entry; determine an authentication outcome based at least in part on the reconciliation of authentication data with the associated data entry and examination of the authentication data for an existence of each of the at least one predetermined authentication characteristics; store an authentication indicator associated with the data entry.

The Patent Application No. JP2022017327A, titled “Interface display method and device for providing social network service via anonymous infrastructure profile” pertains to An interface that provides a social network service via an anonymous infrastructure profile displays a first list of anonymous infrastructure chat rooms generated by instant messaging service user accounts by using a first area of a first page within an instant messaging service interface, and displays a second list of anonymous infrastructure profiles generated in conjunction with user accounts by using a first area of a second page within the instant messaging service interface to display an interface for providing a social network service via an anonymity infrastructure profile selected from the second list.

In view of these challenges, a rising demand is observed for innovative solutions aimed at enhancing the authenticity and credibility of user interactions and content within online social networks. Users, motivated by a quest for more substantial connections and verifiable interactions, are actively exploring avenues to amalgamate their virtual presence with their real-world identity.

### SUMMARY OF THE INVENTION

The present disclosure introduces an integrated system tailored to ensure authenticity verification and enhance user engagement within social networking platforms. The system incorporates a plurality of specialized modules that synergistically orchestrate a seamless and reliable online user experience. Users are empowered to upload both avatar and real images associated with profiles, access “real” content via a designated feature, and actively interact with authentic content. Access permissions, real image verification, and user engagement prompts are efficiently administered by the system through dedicated modules. This integrative approach endeavors to cultivate credibility and meaningful interactions within online social networking environments. In sum, this integrated system establishes a comprehensive solution, augmenting authenticity assurance and user engagement, thereby harmonizing diverse functionalities to forge an enriched online social environment.

The present invention discloses a method that involves the implementation of a “real reaction” feature within an online social network, with the objective of enhancing authenticity, user engagement, and content identification. The method provides users the capability to upload both their avatar image, associated with a pseudonym, and real images corresponding to their authentic identity onto their profiles within the online social network platform. the method facilitates user access to “real” content through the real reaction feature, allowing them to seamlessly alternate between displaying their avatar image and the genuine profile image through intuitive swiping actions on the profile image icon. The method empowers the users to actively express responses to a diverse array of unique and authentic content accessible on the online social network platform. The method further expedites user comment access requests by ascertaining the authenticity of their real image. Furthermore, the method establishes a holistic framework for the integration of the “real reaction” feature, fostering bona fide user interactions, and facilitating discernment of authentic content within the online social network platform.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing a system for authenticity verification and user engagement in social networking platforms.

FIG. 2 illustrates a flow diagram disclosing a method for implementing a “real reaction” feature in an online social network.

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention.

The present invention discloses an integrated system custom-designed for the purpose of ensuring authenticity validation and augmenting user engagement within social networking platforms. The system facilitates active interaction with authentic content. The system adeptly administers access permissions, verifies real images, and prompts user engagement. system presents a holistic solution, enhancing authenticity validation and user engagement, thus harmonizing diverse functionalities to establish an enriched online social environment.

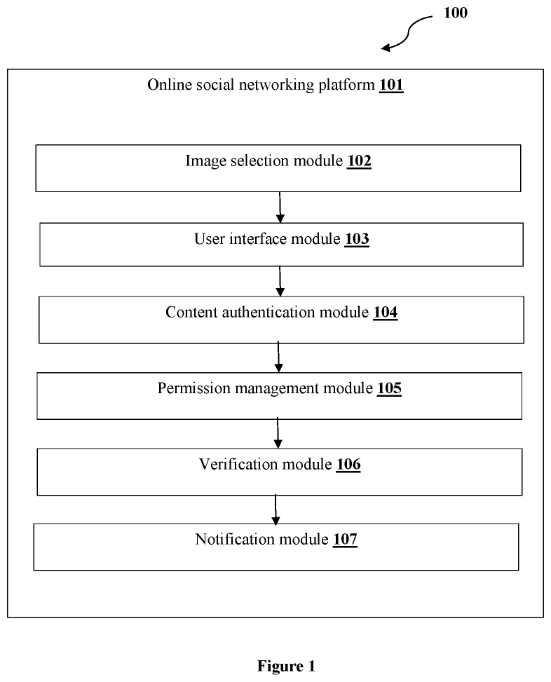

FIG. 1 illustrates a block diagram disclosing an integrated system for authenticity verification and user engagement in social networking platforms. The system (100) comprises an image selection module (102) configured to enable multiple users to upload both an avatar image and a real image linked to their profiles' icon on an online social network platform (101), wherein the avatar image is linked to a pseudonym, and the real image is associated with ae user's real-life image. Further, the system (100) comprises a user interface module (103) configured to enable the users to access real content via a real reaction feature on the online social network platform (101), facilitating the users to switch between displaying the avatar image and the real profile image by swiping left or right on a profile image icon. Further, the system (100) comprises a content authentication module (104) configured to empower the users to express one or more responses to a plurality of unique and authentic content available on the online social network's platform (101) using the real reaction feature. The content authentication module (104) employs Artificial Intelligence (AI) in conjunction with the user reactions to ascertain the authenticity and uniqueness of the content.

Further, the system (100) comprises a permission management module (105) configured to control access to the real image profile featured on the profile image icon, wherein the access is contingent upon the user permissions. Further, the system (100) comprises a verification module (106) configured to facilitate a user's request for comment access by validating the authenticity of the user's real image profile through a comparison between the provided profile picture and the real image obtained using a live camera feed image. Furthermore, the system (100) comprises a notification module (107) configured to dispatch a placeholder notification to the users engaged in the swiping action aimed at locating the real image, wherein in instances where the real image is not found, prompting the users to add their real image thereby granting them access to functionalities for commenting and replying, along with displaying their authentic identity to the other users on the online social network platform (101).

In an embodiment of the present invention, the image selection module (102) enables users to upload both the avatar image and the real image linked to their profile's image icon, thereby establishing the foundational connection, capturing the visual identity choices of users for their profiles. Further, the user interface module (103) builds upon the image selections, allowing users to access the real content through the real reaction feature, further, enabling the users to switch between displaying the avatar and real profile images through intuitive swiping gestures on the profile image icon, linking the user's visual representation with their engagement experience.

In an embodiment, the content authentication module (104) extends the user experience by empowering them to express responses to the unique and authentic content, thereby connecting the user's engagement with the real content to their chosen visual identity. Further, the permission management module (105) solidifies the connection by controlling access to the real image profile on the profile image icon, contingent upon the user permissions. This ensures that access to the authentic identity representation aligns with the user-defined permissions. Furthermore, by validating the authenticity of the user's real image through a comparison between the provided profile image and the real image obtained using the live camera feed, the system ensures (100) a seamless alignment between the user identity and their ability to participate in the engagement activities. Additionally, when the users attempt to locate the real image and it's not found, the notifications prompt the users to add their real image, thereby reconnecting their visual identity to their ability to comment, reply, and engage with others in an authentic manner.

In an embodiment, the system (100) is configured to anticipate positive engagement results and allocate correlated scores, thus augmenting the online social network platform's (101) effectiveness in cultivating the creation of the authentic content and a more secure online community.

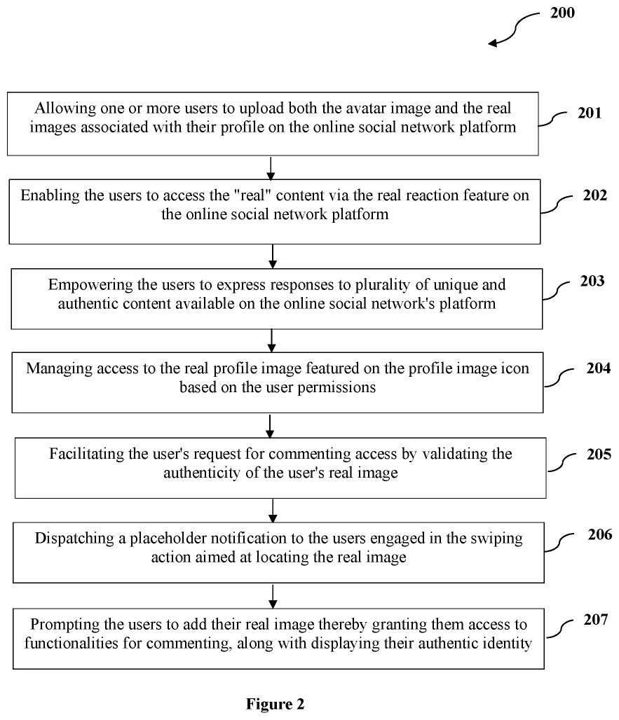

FIG. 2 illustrates a flow diagram disclosing a method for implementing a “real reaction” feature in an online social network. The method (200) unfolds through a series of steps, commencing with step (201), which involves allowing multiple users to upload both the avatar image and the real images associated with their profile on the online social network platform, wherein the avatar image is associated with the pseudonym, and the real image is linked to the user's real-life image. In an embodiment, the users upload both the avatar image and the real images associated with their profile on the online social network platform accompanied by a real name for display.

In step (202), the users are enabled to access the “real” content via the real reaction feature on the online social network platform, thereby facilitating the switching between displaying the avatar image and the real profile image by swiping left or right on the profile image icon. In step (203), the users are empowered to express one or more responses to plurality of unique and authentic content available on the online social network's platform using the real reaction feature.

In step (204), access to the real profile image featured on the profile image icon is managed based on the user permissions. In step (205), the user's request for commenting access is facilitated by validating the authenticity of the user's real image through a comparison between the provided profile picture and the real image obtained using a live camera feed image. In step (206), a placeholder notification is dispatched to the users engaged in the swiping action aimed at locating the real image. Further, in step (207), the users are prompted to add their real image thereby granting them access to functionalities for commenting and replying, along with displaying their authentic identity to the other users on the online social network platform, in instances where the real image is not found.

The disclosed system (100) offers several advantageous features that collectively enhance the overall user experience and authenticity within online social networking platforms. By enabling users to upload both avatar and real images linked to their profiles, the system establishes a genuine visual representation of individuals, fostering authenticity in user interactions. The seamless transition between displaying avatar and real profile images through the user interface module enhances the engagement experience, allowing users to align their chosen identity with their interactions. Further, the system's (100) multifaceted approach contributes to a secure, transparent, and genuine online social networking environment, fostering meaningful connections and interactions while enhancing user control and trustworthiness.

TABLE 1
Reference numbers:

| | Reference |
|---|---|
| Components | Numbers |
| System | 100 |
| Online Social Networking Platform | 101 |
| Image selection module | 102 |
| User interface module | 103 |
| Content authentication module | 104 |
| Permission management module | 105 |
| Verification module | 106 |
| Notification module | 107 |

We claim:

1. An integrated system for authenticity verification and user engagement in social networking platforms, the system (100) comprising:
a. an image selection module (102) configured to enable one or more users to upload both an avatar image and a real image linked to t profile's image icon on an online social network platform (101), wherein the avatar image is linked to a pseudonym, and the real image is associated with the user's real-life image;
b. a user interface module (103) configured to enable the users to access “real” content through a real reaction feature on the online social network platform (101), facilitating the users to switch between displaying an avatar image and a real profile image by swiping left or right on a profile image icon;
c. a content authentication module (104) configured to empower the users to express one or more responses to a plurality of unique and authentic content available on the online social network's platform (101) using the real reaction feature;
d. a permission management module (105) configured to control access to the real image profile featured on the profile's image icon, wherein the access is contingent upon the user permissions;
e. a verification module (106) configured to facilitate a user's request for comment access by validating the authenticity of the user's real image through a comparison between the provided profile picture and the real image obtained using a live camera feed image; and
f. a notification module (107) configured to dispatch a placeholder notification to the users engaged in the swiping action aimed at locating the real image, in instances where the real image is not found, prompting the users to add their real image thereby granting them access to functionalities for commenting and replying, along with displaying their authentic identity to the other users on the online social network platform (101).

2. The system (100) as claimed in claim 1, wherein the content authentication module (104) employs Artificial Intelligence (AI) in conjunction with the user reactions to ascertain the authenticity and uniqueness of the content.

3. The system (100) as claimed in claim 1, wherein the system (100) is configured to anticipate positive engagement results and allocate correlated scores, thus augmenting the online social network platform's (101) effectiveness in cultivating the creation of the authentic content and a more secure online community.

4. The system (100) as claimed in claim 1, wherein the system (100) enhances the user authenticity, accountability, and interaction quality on the online social networking platform (101) by encouraging authentic interactions based on the real identity representation.

5. A method for implementing a “real reaction” feature in an online social network, to enhance authenticity, user engagement, and content identification, the method (200) comprising the steps of:
a. allowing one or more users to upload both the avatar image and the real images associated with their profile on the online social network platform, wherein the avatar image is associated with the pseudonym, and the real image is linked to the user's real-life image (201);
b. enabling the users to access the “real” content via the real reaction feature on the online social network platform, thereby facilitating the switching between displaying the avatar image and the real profile image by swiping left or right on the profile image icon (202);
c. empowering the users to express one or more responses to plurality of unique and authentic content available on the online social network's platform using the real reaction feature (203);
d. managing access to the real profile image featured on the profile image icon based on the user permissions (204);
e. facilitating the user's request for commenting access by validating the authenticity of the user's real image through a comparison between the provided profile picture and the real image obtained using a live camera feed image (205);
f. dispatching a placeholder notification to the users engaged in the swiping action aimed at locating the real image (206); and
g. prompting the users to add their real image thereby granting them access to functionalities for commenting and replying, along with displaying their authentic identity to the other users on the online social network platform, in instances where the real image is not found (207).

6. The method (100) as claimed in claim 5, wherein the users upload both the avatar image and the real images associated with their profile on the online social network platform accompanied by a real name for display.
